(19) United States
(12) Patent Application Publication
(10) Pub. No.: US 2024/0253496 A1
(43) Pub. Date: Aug. 1, 2024

(54) CONFIGURABLE ELECTRIC VEHICLE CHARGING SYSTEM HAVING CENTRALLY LOCATED POWER MODULES

(71) Applicant: ADDÉNERGIE TECHNOLOGIES INC., Québec City (CA)

(72) Inventors: Olivier RAYMOND, Montreal (CA); Samuel MOON, Austin, TX (US); Anthony DUYS, Merrimac, MA (US); Adam Thomas PRATHER, Austin, TX (US); Erlend Henry Olav MELING, Austin, TX (US); Simon LAMARRE, Québec City (CA); Simon DUGRÉ, Québec (CA); François PERREAULT, Lévis (CA)

(73) Assignee: ADDÉNERGIE TECHNOLOGIES INC., Québec City, QC (CA)

(21) Appl. No.: 18/424,124

(22) Filed: Jan. 26, 2024

Related U.S. Application Data
(60) Provisional application No. 63/481,733, filed on Jan. 26, 2023.

(51) Int. Cl. B60L 53/31; F21S 8/08; H02J 7/00

(52) U.S. Cl. CPC B60L 53/31; F21S 8/088; H02J 7/0042

(57) ABSTRACT

In an aspect, a monolithic electric vehicle (EV) charging station is described. The charging station includes a first EV charger at a first side and a second EV charger at a second side. The charging station includes a power module cabinet portion between the first EV charger and the second EV charger, the power module cabinet housing one or more power modules configured to dynamically distribute power to the first EV charger and the second EV charger.

### FIELD

This application relates to electric vehicle charging stations. More particularly, one or more embodiments pertain to configurable electrical vehicle charging stations that may be configured for pull-in and pull-through installations.

### BACKGROUND

An electric vehicle (EV) charging station is an element of infrastructure that supplies direct current (DC) or alternating current (AC) electric energy for the recharging of electric vehicles, such as plug-in battery electric vehicles, including electric cars, trucks, buses, and other vehicles including high and low range electric vehicles and plug-in hybrids.

Electric vehicle users often wish to rapidly charge such vehicles and, in order to accommodate such users, some EV charging stations are high-voltage charging stations which deliver high power to the electrical vehicle during charging. For example, some chargers, which are often referred to as level 3 or Direct Current Fast Chargers (DCFC) may deliver up to 350 kW of power at around 400 VDC. Even faster charging is possible with yet higher voltage and power capabilities.

High-speed chargers often use a distributed architecture in which power conversion and supply circuitry, such as power modules, reside in a separate cabinet that is remotely positioned from other customer-facing electric vehicle charging equipment, such as dispensers that include connecting cables that connect to an electric vehicle.

This distributed architecture may, in at least some circumstances, result in a number of problems or obstacles for deployments. For example, such an architecture may consume a large amount of real estate since the separate cabinet that houses the power conversion and supply circuitry must be placed remote from, but somewhat proximate to, the customer-facing electric vehicle charging equipment.

Additionally or alternatively, the customer-facing electric vehicle charging equipment typically resembles a relatively thin post or column. This post or column sometimes services multiple vehicles by having multiple charging cables but the nature of the post or column sometimes causes potential customers to believe that a charger is fully utilized when only a single one of the charging cables is, in fact in use.

Additionally or alternatively, it may be that the distributed nature of the deployments described above result in inefficiencies and deployment difficulties since cabling must be run between each dispenser and one of the remote cabinets. Such deployments may be expensive due to the cabling requirements and, in at least some situations, there may be a risk of power loss, particularly where the dispenser is relatively far from the remote cabinet.

Additionally or alternatively, it is common to install bollards such as steel bollards in and around EV charging stations to protect the equipment from vehicles. The distributed architecture referred to above often requires the installation of a great number of bollards since bollards are often installed around both the customer-facing EV charging equipment and also the separate cabinets.

While some EV chargers, typically called monolithic chargers, do not use a distributed architecture, such chargers often have similar drawbacks to chargers having a distributed architecture. For example, such chargers are often columnar in appearance and they make it difficult for charging of multiple vehicles since it may be difficult to see that additional charging capacity is available when a charger is in use (e.g., because a charger may be obscured by a vehicle). Further, such chargers may be difficult to use since, for example, the cabling may be difficult to reach a vehicle's charging port depending on which side of the vehicle the port is on, etc. Furthermore, it may be difficult to access certain components of the charger such as the power modules. Additionally or alternatively, where charging stations have multiple charging cables, many existing solutions result in situations in which the cables may become entangled with one another. Further, in existing solutions, power modules are often located at or near a permitter of the EV charger which may make such chargers more vulnerable to vehicular impacts.

Furthermore, some chargers are only suited to either pull up (e.g., where a vehicle is parked in a parking space) or pull through style charging (e.g., similar to a gas station), but not both styles of charging.

Thus, there is a need for improved EV charging stations that address one or more of these problems or other problems.

### BRIEF DESCRIPTION OF THE DRAWINGS

Embodiments are described in detail below, with reference to the following drawings:

FIG. 1 is a perspective view of an electric vehicle (EV) charging station in accordance with an example of the present application;

FIG. 2 is a left side elevation view of the EV charging station of FIG. 1 in accordance with an example of the present application;

FIG. 3 is a top plan view of an EV charging station configured for pull-up charging in accordance with an example implementation of the present disclosure;

FIG. 4 is a front elevational view of the EV charging station as configured for pull-up charging in FIG. 3;

FIG. 5 is a side elevational view of the EV charging station as configured for pull-up charging in FIG. 3;

FIG. 6 is a top plan view of an EV charging station configured for pull-through charging in accordance with an example implementation of the present disclosure;

FIG. 7 is a front elevational view of the EV charging station as configured for pull-through charging in FIG. 6;

FIG. 8 is a side elevational view of the EV charging station as configured for pull-through charging in FIG. 6;

FIG. 9 is a front elevational view of an EV charging station in a first configuration which may be used in a pull-up charging deployment;

FIG. 10 is a rear elevational view of the EV charging station of FIG. 9;

FIG. 11 is a left side elevational view of the EV charging station of FIG. 9, with the right side being a mirror view;

FIG. 12 is a top plan view of the EV charging station of FIG. 9;

FIG. 13 is a front perspective view of the EV charging station of FIG. 9;

FIG. 14 is a front elevational view of an EV charging station in a second configuration which may be used in a pull-through charging deployment, with the rear view being the same;

FIG. 15 is a left side elevational view of the EV charging station of FIG. 14, with the right side being a mirror view;

FIG. 16 is a top plan view of the EV charging station of FIG. 14;

FIG. 17 is a front perspective view of the EV charging station of FIG. 14;

FIG. 18 is a front elevational view of an EV charging station in the first configuration, illustrating example dimensions in inches;

FIG. 19 is a right side elevational view of the EV charging station of FIG. 18 illustrating example dimensions;

FIG. 20 is a front elevational view showing of an EV charging station in which a front panel of a middle portion has been removed; and

FIG. 21 is an exploded assembly view of a portion of an EV charging station illustrating configuration options.

Like reference numerals are used in the drawings to denote like elements and features.

### DETAILED DESCRIPTION OF EXAMPLE EMBODIMENTS

In an aspect, a monolithic electric vehicle (EV) charging station is provided. The EV charging station may include a first EV charger at a first side. The EV charging station may further include a second EV charger at a second side. The EV charging station may further include a power module cabinet portion between the first EV charger and the second EV charger. The power module cabinet may house one or more power modules configured to dynamically distribute power to the first EV charger and the second EV charger.

In some implementations, a width of the monolithic EV charging station is within 5% of a width of a parking space at which the EV charging station is deployed.

In some implementations, the width of the monolithic charging station is between 74 and 100 inches.

In some implementations, the EV charging station is situated in a position in which the first EV charger is at an approximate midpoint of a first parking space and the second EV charger is at an approximate midpoint of a second parking space.

In some implementations, the first EV charger and the second EV charger are dispensers which dispense supplied power from the one or more power modules and which do not, themselves, include power modules.

In some implementations, the first EV charger and the second EV charger provide a buffer zone to reduce the effect on the power modules from an impact at one or more sides of the EV charging station.

In some implementations, the first and second EV chargers are mounted to a frame and at least one of the first and second EV chargers are configured with a removable portion associated with a holster which may be replaced with a backer panel. At least one of the first and second EV chargers may include a backer panel behind that removable portion which is configured to be replaced with a removable portion associated with a holster to convert the EV charging station between a same-side station and an opposite-side station.

In some implementations, the first EV charger may have a first columnar region The second EV charger may have a second columnar region. The first and second columnar regions may extend above the power module cabinet to visually distinguish the first and second EV chargers.

In some implementations, the EV charging station may include a first lighting canopy associated with the first EV charger and mounted above the first EV charger and a second lighting canopy associated with the second EV charger and mounted above the second EV charger. The first lighting canopy and the second lighting canopy are separate and distinct lighting canopies.

In some implementations, the monolithic EV charging station may include a controller coupled with the first EV charger and the second EV charger and a first light associated with the first lighting canopy and a second light associated with the second lighting canopy. The controller may be configured to control the first light to indicate whether the first EV charger is available for use and to control the second light to indicate whether the second EV charger is available for use.

In another aspect, a method of configuring EV charging stations in different configurations using a common structure is described. The method may include: configuring a first EV charging station as a same-side charging station by: installing a first EV charger panel at a front side of the first EV charging station; installing a second EV charger panel at the front side of the first EV charging station; installing a first backer panel behind the first EV charger panel; and installing a second backer panel behind the second EV charger panel. The method may also include configuring a second EV charging station as an opposite-side charging station by: installing another first EV charger panel at a front side of the second EV charging station; installing another second EV charger panel at a rear side of the second EV charging station; installing another first backer panel behind the first EV charger panel; and installing another second backer panel in front of the second EV charger panel. The first and second EV charging stations may include commonly-configured structures to which the EV charger panels and backer panels are attached.

In some implementations, the commonly-configured structures include commonly-configured frames.

In some implementations, the first EV charging station and the second EV charging station have a common width and height.

In some implementations, the common widths is between 74 and 100 inches.

In some implementations, each of the first and second EV charging stations may include: a first EV charger at a first side, the first EV charger associated with the first EV charger panel in the case of the first EV charging station and with the another first EV charger panel in the case of the second EV charging station; a second EV charger at a second side, the second EV charger associated with the second EV charger panel in the case of the first EV charging station and with the another second EV charger panel in the case of the second EV charging station; and a power module cabinet portion between the first EV charger and the second EV charger. The power module cabinet may house one or more power modules configured to dynamically distribute power to the first EV charger and the second EV charger. The power module cabinet portions may have a common configuration for both the first and second EV charging stations.

In some implementations, the first and second EV charging stations may be commonly configured with common components apart from differing configurations of the EV charging panels.

In some implementations, the method may include: converting the first EV charging station from a same-side charging station to an opposite side charging station by replacing the first backer panel with an EV charger panel and replacing the first EV charger panel with a backer panel.

In some implementations, the method may include converting the second EV charging station from an opposite-side charging station to a same-side charging station by replacing the another first backer panel with an EV charger panel and replacing the another first EV charger panel with a backer panel.

In some implementations, the first EV charger panel may be installed at a left side of the first EV charging station and the second EV charger panel may be installed at a right side of the EV charging station. The another first EV charger panel may be installed at a left side of the second EV charging station and the another second EV charger panel may be installed at a right side of the second EV charging station.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

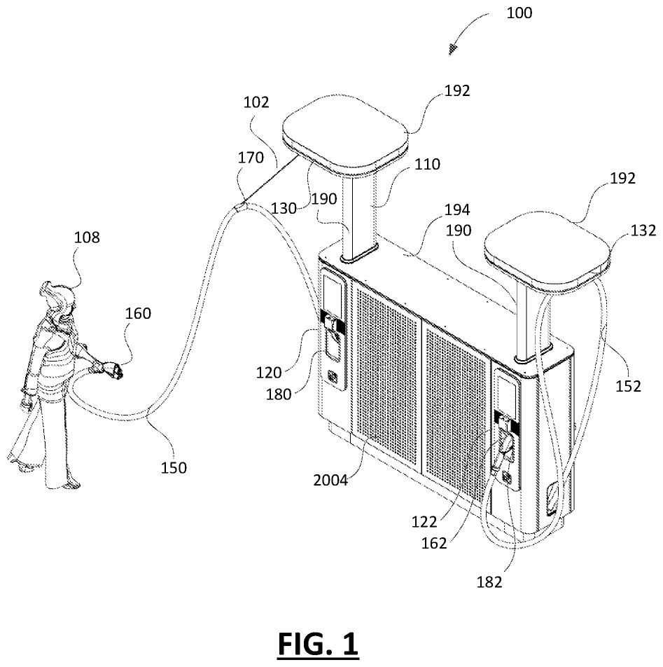

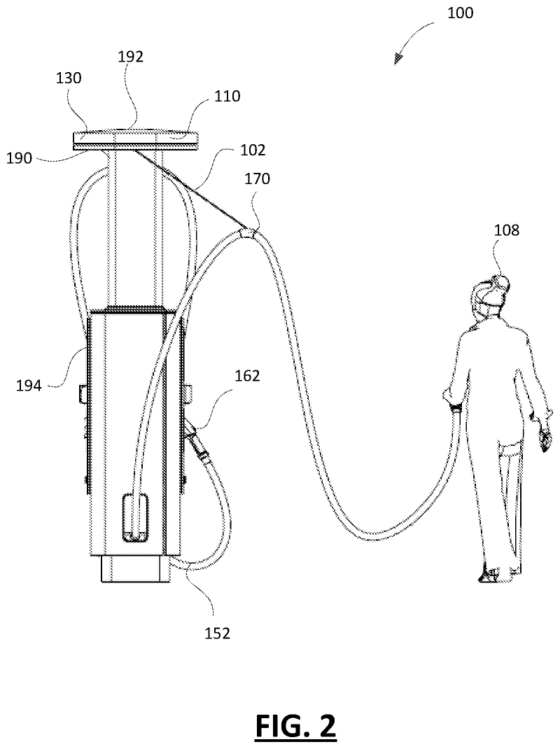

Reference is made to FIGS. 1 and 2, which illustrate an electric vehicle (EV) charging station 100 in both perspective (FIG. 1) and left side (FIG. 2) views. The EV charging station may also be referred to herein as a charging station. The EV charging station 100 may include one or more EV chargers. In the illustrated example, the EV charging station 100 includes two EV chargers—a first EV charger 120 and a second EV charger 122. In other implementations, the EV charging station 100 may include a greater or lesser number of EV chargers than the EV charging station 100 of FIGS. 1 and 2.

Each of the EV chargers 120, 122 may allow the EV charging station 100 to concurrently charge a separate electric vehicle. For example, an EV charging station 100 having two EV chargers may concurrently charge two electric vehicles, an EV charging station 100 having three EV chargers may concurrently charge three EVs, and so on.

The EV chargers may be of various types including, for example, any one or more of Level 1 chargers, Level 2 chargers, Level 3 chargers, DC Fast chargers (DCFC), Level 4 chargers, and so on. In one implementation, the EV charging station 100 may include an EV charger that charges an EV at 400 volts or more.

The EV charging station may be installed at any one or more of: a residence, a business, a parking facility, or in an operating environment of another type. In at least one implementation, the EV charging station may be a roadside EV charging station.

Each of the EV chargers 120, 122 may include a charging cable 150, 152. For example, a first EV charger 120 may include a first charging cable 150 and a second EV charger 122 may include a second charging cable 152.

Each of the EV charging cables 150, 152 may, at one end, include a connector 160, 162. For example, the first EV charging cable 150 may include a first connector 160 and the second EV charging cable 152 may include a second connector 162. The first and second connectors 160, 162 may be of the same type or of different types. The connectors 160, 162 are configured to connect the EV chargers to an electric vehicle. More specifically, the connectors 160, 162 are configured to mate with a charging port of an electric vehicle. The connectors 160, 162 may be configured according to standards such as, for example CHAdeMO standards and/or SAE Combo standards. In some implementations, the connectors 160, 162 may be of one or more of the following types: Port J1772, CHAdeMO, SAE Combo CCS, Tesla HPWC and Tesla Supercharger.

An operator 108 may use the EV charging station 100 to charge an electric vehicle by extending one of the charging cables 150, 152 until one of the connectors 160, 162 can be aligned with the charging port of the electric vehicle. Then, the operator 108 may plug the connector 160, 162 into the charging port and the EV charging station 100 will initiate charging of a battery of

Each EV charger 120, 122 may include a holster 180, 182 or other holder for holding an associated connector 160, 162 off the ground when an EV charger is not in use. The holster 180 may serve to protect the EV charger 120, 122 from damage due to environmental factors, such as rain, snow, etc. Additionally or alternatively, the holster 180 may serve to protect the EV charger 120, 122 from accidental damage from, for example, inadvertent contact with vehicles. The holster 180, 182 may, additionally or alternatively, hold the connector 160, 162 at a height that makes it more accessible. For example, the EV charger 120, 122 may hold the connector 160, 162 off of the ground at a height above the ground that makes it easy for the operator to grab the connector 160, 162 without having to bend. The holster 180, 182 may, in at least some implementations, hold the connector 160, 162 at a height above the ground that allows an operator in a wheelchair to easily grab the holster 180, 182.

The enclosure 110 may include multiple parts. For example, the enclosure 110 may include a support 190, an upper housing 192 and a lower housing 194. The support 190 may be a columnar support. The support 190 may house one or more components of the EV charging station 100 such as one or more electrical wires providing power and/or communications to components housed within the upper housing 192. In some implementations, one or more such electrical wires may provide communications between components housed within the upper housing 192 and components housed within the lower housing 194.

The support 190 may support the upper housing 192 so that the upper housing remains fixed relative to one or both of the support 190 and the lower housing 192. The support 190 may hold the upper housing 192 in a generally horizontal orientation so that the upper housing 192 acts as a canopy or shade. The upper housing 192 may house a cable management system which may be used to facilitate retraction or extension of the charging cable 150, 152 by retracting and extending a mechanical wire 102 that is connected to a charging cable 150 via a coupler 170. The cable management system or a portion thereof may be located in other regions including, for example, the support 190.

The upper housing 192 may include one or more lights such as, for example, light-emitting diode (LED) lights. Each light may be associated with a particular one of the EV chargers and it may be controlled to indicate a status of the particular one of the EV chargers which it is connected to. For example, the light may be controlled, by an associated controller, to indicate one or more of the following conditions: the EV charger is charging, the EV charger is available, the status of charge, the EV charger is out of service, etc. In at least some implementations, different lighting schemes may be used to communicate a different status. For example, color may be used to distinguish different EV charger status. A first lighting color may represent a first condition and a second lighting color may represent a second condition. The lights may be referred to as lighting canopies 130, 132.

In the illustrated example, each of the EV chargers has a separate lighting canopy 130, 132 associated with that EV charger 120, 122. Each of the lighting canopies are separate and distinct features. In this way, a potential operator may easily identify the status of each of the EV chargers 120, 122, even though the EV chargers are coupled to one another, as will be described below. Put differently, separate lighting canopies may be provided to separately identify the status of each charger even though the EV chargers are provided in a monolithic form in which both EV chargers are coupled to one another.

In the illustrated example, each lighting canopy 130, 132 includes at least one wrap-around light. The wrap-around light map wrap around the complete perimeter of the lighting canopy. In this way, the status of the associated EV charger may be easily identified by a potential operator from any side of the EV charger 120, 122. The wrap-around lights may wrap around a permitter that is on a horizontal plane or a substantially horizontal plane.

In the illustrated example, each of the lighting canopies 130, 132 is a separate and distinct feature. A first lighting canopy 130 is mounted above the first EV charger 120 and a second lighting canopy 132 is mounted above the second EV charger 122. Conveniently, in this way, the status of each of the EV chargers 120, 122 may be easy for operators and potential operators to identify. Additionally or alternatively, the separate lighting canopies 130, 132 may highlight to potential operators that it is possible to charge a second electric vehicle at the EV charging station 100 even if the EV charging station is already in use by a first electric vehicle.

In at least some implementations, the number of lighting canopies 130, 132 corresponds to the number of EV chargers 120, 122 included in the monolithic EV charging system. For example, two lighting canopies 130, 132 are present in the illustrated EV charging system 100 of FIG. 1 since there are two EV chargers 120, 122.

In the illustrated example, the lower housing 194 is substantially a rectangular prism. The lower housing 194 includes both the first EV charger 120, the second EV charger 122 and a power cabinet 2004.

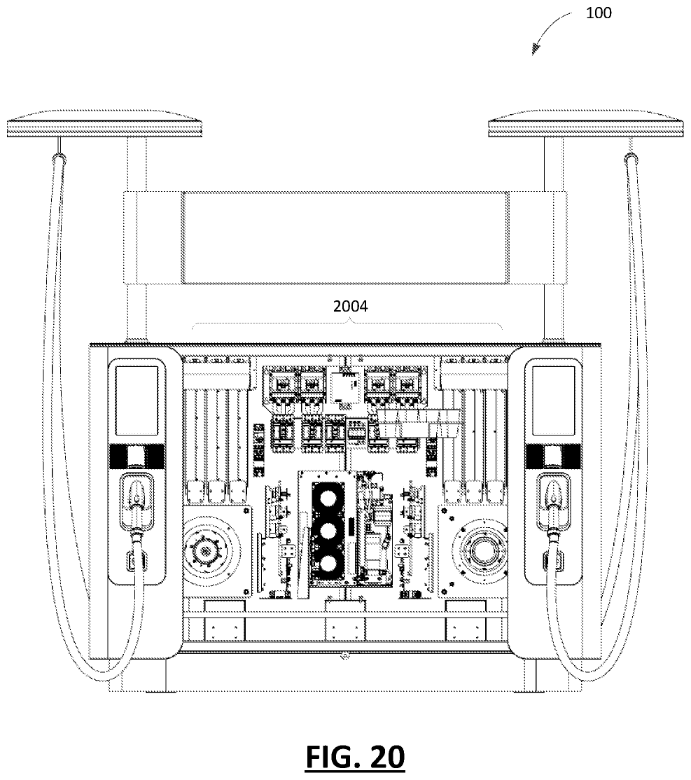

As illustrated, for example, in FIG. 20, the power cabinet houses and includes power conversion and supply circuitry, such as power modules. The power cabinet may house and include components of the EV charging station that would typically be, in a distributed architecture, located in a separate and remotely positioned power cabinet. The power cabinet may be referred to as one or more of: a power bank, a power engine, a power block, a power unit, a power system.

The EV chargers 120, 122 do not include the power modules and power conversion and supply circuitry. Rather, the EV chargers 120, 122 in the illustrated example, are dispensers which simply dispense the supplied power from the power modules to an electric vehicle which connects via one of the charging cables 150, 152. Thus, the reference to the EV chargers 120, 122 may be replaced with a reference to “dispensers”. Other terms may also be used to refer to the dispensers including, for example, charge posts, power links, user units and customer-facing electric vehicle charging equipment.

The EV chargers 120, 122 are located at the sides of the EV charging station 100 and the power cabinet 2004 is situated between the EV chargers 120, 122. Conveniently, situating the power cabinet 2004 between the two EV chargers 120, 122 may provide one or more benefits in at least some implementations. For example, placing the power modules and other power conversion and supply circuitry immediately adjacent to the EV chargers 120, 122 may result in less cabling requirements than in a distributed deployment and/or less power loss over such cabling. Further, the power cabinet 2004 may house dynamic power modules which adaptively provide power to whichever EV charger 120, 122 requires such power and which allow one of the EV chargers 120, 122 to consume more power when the other of the EV chargers is not in use. Further, in at least some scenarios, by situating the power cabinet 2004 between the EV chargers, it may be easy and convenient for a technician to access the interior of the power cabinet 2004. Such access may be necessary for servicing or, in at least some implementations, in order to allow for upgrading of power modules to allow for higher speed charging.

Further, in at least some implementations and for at least some deployments, situating the power cabinet 2004 so that it is sandwiched between the two EV chargers 120, 122 may result in safer installations. For example, it may be that the EV chargers 120, 122 provide a buffer or crunch zone so that any impact to the EV chargers 120, 122 from certain sides is less likely to result in damage to the sensitive and expensive components housed in the power cabinet 2004. Further, in at least some deployments, the sandwiched power cabinet infrastructure may result in a need for fewer safety bollards and/or real estate, particularly when compared with a distributed system.

The power cabinet 2004 may include one or more removable panels to allow a technician to access an interior of the power cabinet 2004. For example, as illustrated in FIG. 20, a panel may be removed to provide technician access. In at least some implementations, the panel(s) may be movable to provide access. For example, a hinged panel may be swung open to provide interior access.

The lower housing 194 is, in the illustrated example, substantially a rectangular prism. The lower housing 194 may include a toe kick portion at a bottom region. The lower housing 194 may include rounded or chamfered edges which may allow for easy passing of the charging cable 150, 152 around or by such edges.

Each of the EV chargers 120, 122 is associated with a separate columnar region. For example, in the illustrated implementation, the first EV charger 120 has a first column rising above it (i.e., the support 190) and the second EV charger 122 has a second column rising above it (i.e., the other support 190). These columns or columnar regions may provide one or more benefits. For example, each of the columnar regions may visually distinguish to a potential operator that the monolithic EV charging system includes multiple EV chargers. In at least some implementations, the number of columnar regions extending above the lower housing 194 corresponds to the number of EV chargers 120, 122 included in the monolithic EV charging system. For example, two columnar regions are present in the illustrated EV charging station 100 of FIG. 1 since there are two EV chargers.

As will be described below, an EV charging station 100 may be configured as either a pull-through or pull-up orientation by simply swapping out a small number of pieces. This may allow a substantially common unit to be used in both pull-up and pull-through deployments, which serves to reduce manufacturing costs.

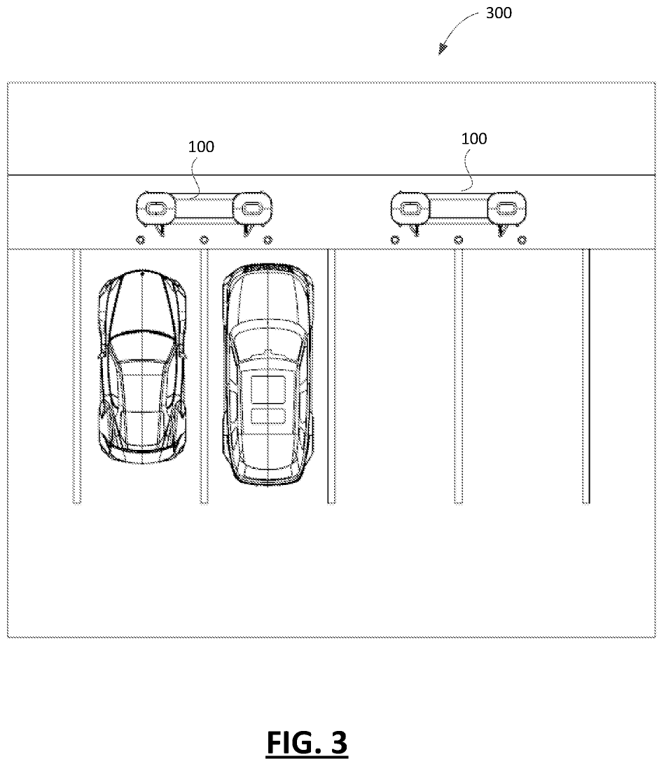

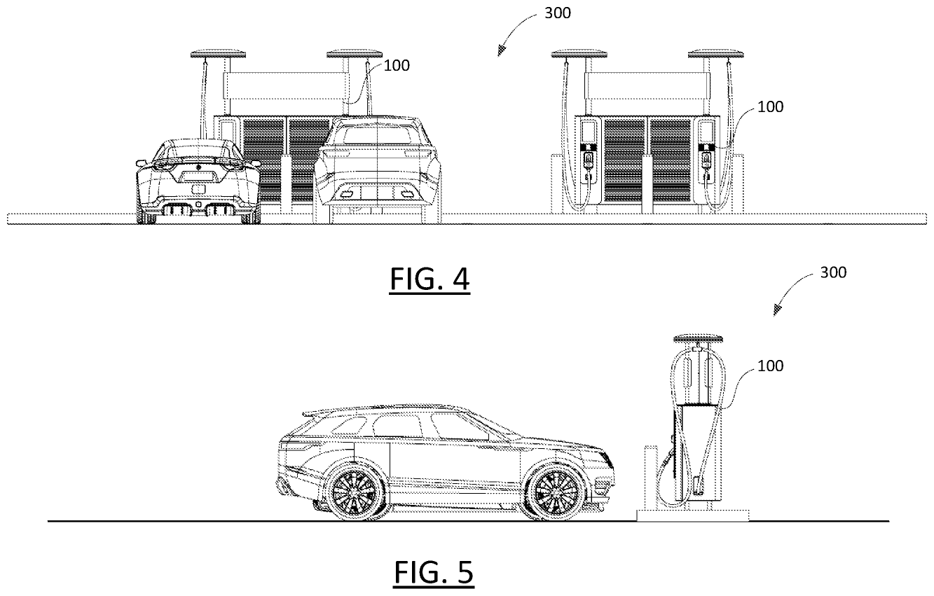

A pull-up deployment 300 will now be illustrated with reference to FIGS. 3 to 5. As illustrated in FIG. 3, a pull-up deployment 300 is a deployment commonly used in a parking lot. In the pull-up deployment, a front of a vehicle (or a rear of the vehicle as the case may be) is oriented facing an EV charging station 100. Parking spaces may be provided in front of (i.e., at a front side of) the EV charging station 100. In this configuration, both EV chargers 120, 122 may be on a same side. For example, both EV chargers 120, 122 may be located on a front side of the EV charging station 100. Each EV charger has its own customer equipment, such as a connector 160, 162, holster 180, 182 and interface (such as a display screen) and, in the pull-up deployment 300, the customer equipment is all located on one side.

Notably, the width of the EV charging station 100 may be similar to the width of a parking space at which it is deployed. For example, in at least one implementation, the width of the EV charging system is within 10% of the width of a parking space at which it is deployed or a standard sized parking space. In at least one implementation, the width of the EV charging station 100 is within 5% of station width of a parking space at which it is deployed or a standard sized parking space. In at least some implementations, the width of the EV charging station 100 is within 2 feet of the width of a parking space at which it is deployed or a standard sized parking space. In at least some implementations, the width of the EV charging station 100 is within 1 foot of the width of a parking space at which it is deployed. The width of the EV charging station 100 is, in some implementations taken from the absolute extremes, which in the illustrated example are defined by the lighting canopies 130, 132. In other examples, the width may be defined differently. For example, the width may be the width between the midpoints of each EV charger 120, 122. Or, the width may be the width of the lower housing 194.

Conveniently, the similar sizing of the EV charging station 100 and the parking space may result in an arrangement where each EV charger 120, 122 and/or each charging cable 150, 152 may be situated at an approximate midpoint of a parking space. For example, a holster of the EV charger 120, 122 may be within 20 centimeters of the midpoint of a parking space, in some implementations. In some implementations, a holster of the EV charger 120, 122 may be within 12 inches of the midpoint. By situating the EV chargers this way, an operator may be able to easily reach a charging port located on either side of the electric vehicle. Additionally or alternatively, this orientation may make it easy for a potential operator to identify a charger that is not already in use even if another charger in the same monolithic unit is already in use.

Additionally or alternatively, the sizing of the EV charging station 100 may serve to prevent power hogging in at least some situations and at least some deployments. Power hogging may occur where an EV charging station is configured with dynamic power sharing between two or more EV chargers 120, 122. When a single charger is in use, it may operate with a greater amount of power than when both EV chargers are in use because the power is shared when both chargers are in use. Some users may attempt to prevent a neighboring car from using the same EV charging station 100 by attempting to block the entire EV charging station 100 with their vehicle. The configuration of the pull-up system described above may render such blocking attempts more difficult.

In the illustrated example, each EV charging station 100 is installed so that a midpoint of the EV charging station 100 taken along its front or rear side aligns with a demarcating feature, such as a line, demarcating two parking spaces. The sizing of the EV charging station 100 also allows for an alternating deployment or installation, such as that illustrated in FIG. 3. In the alternating deployment or installation, a first demarcating feature that demarcates a boundary of a parking space is aligned with an approximate midpoint of a first EV charging station 100 and there is no EV charging station aligned with a second demarcating feature that is adjacent the first demarcating feature. Rather, a second EV charging station 100 is aligned with a third demarcating feature that is adjacent the second demarcating feature. In this way, the parking space between the second and third demarcating features is serviced by the second EV charging station 100. All of the parking spaces associated with the first, second and third demarcating features are serviced by one EV charging station, but there is a gap between the first and second EV charging stations. The gap may be approximately the width of a parking space. The gap may allow for pedestrian traffic between the EV charging stations.

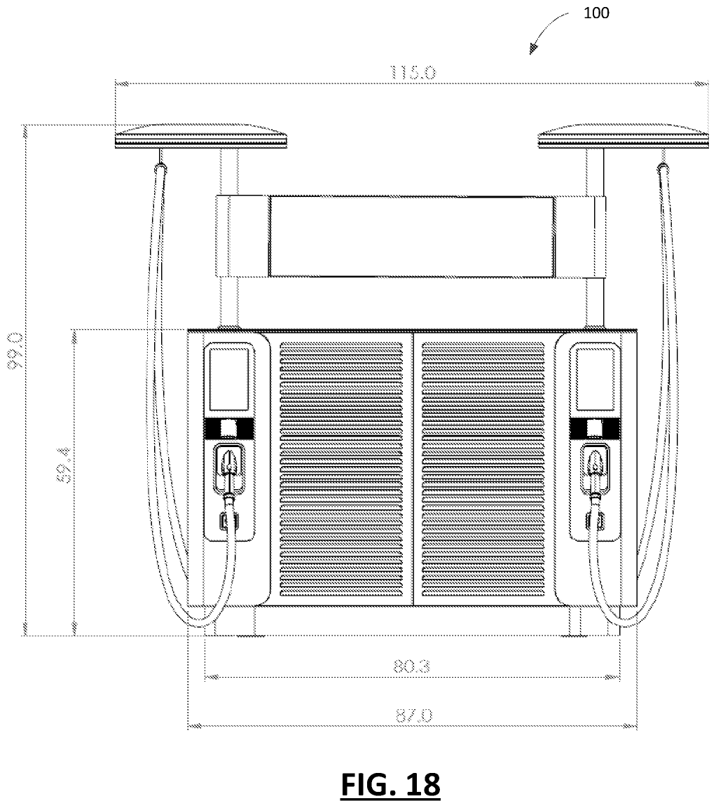

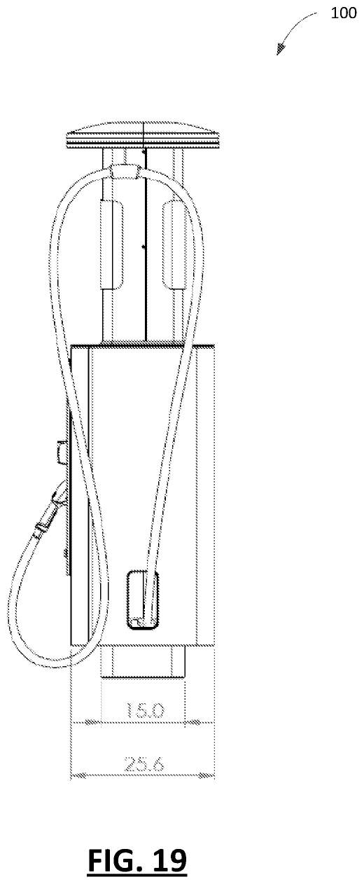

In some examples, one or more of the dimensions of the EV charging station 100 may be the same or similar (e.g., within 15%) of the dimensions illustrated in inches in FIG. 18 or 19. For example, the distance between left and right sides of a housing that includes the EV chargers and the power cabinet may be 87″ plus or minus 15%.

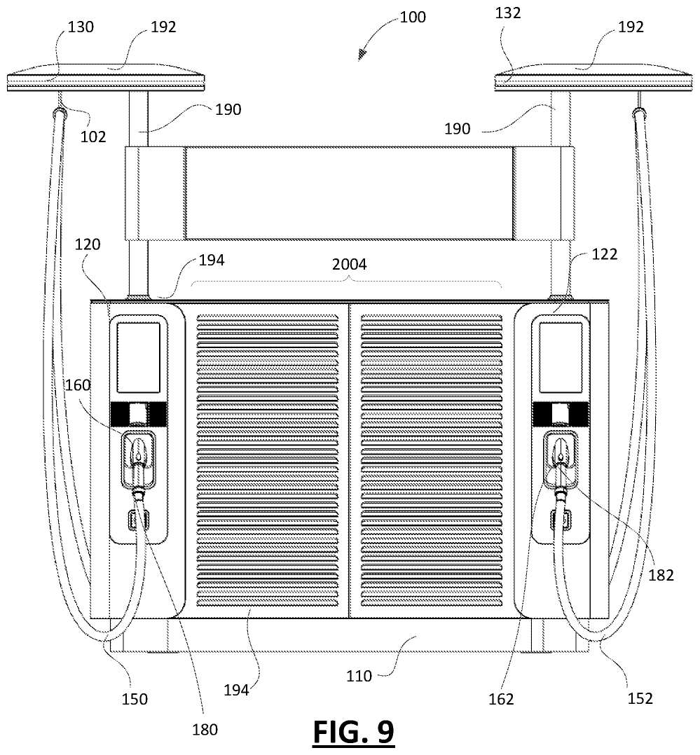

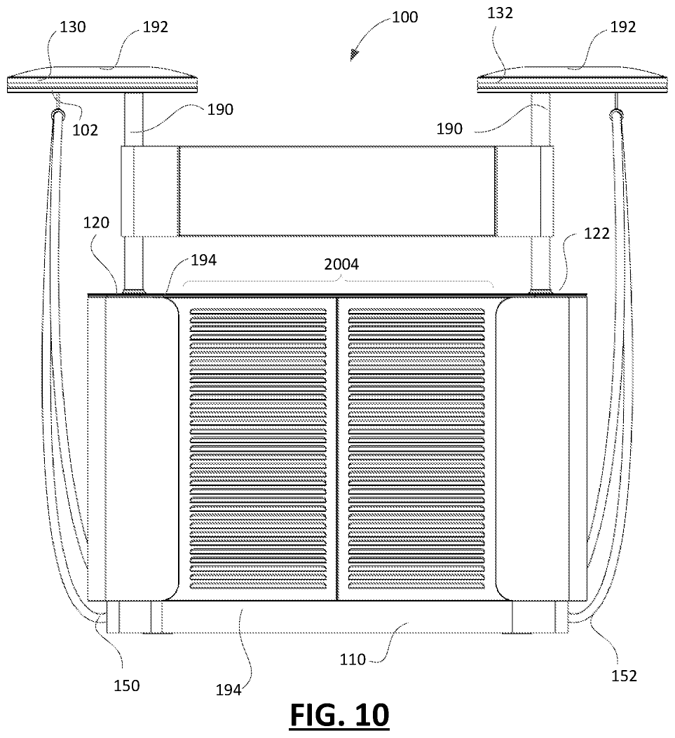

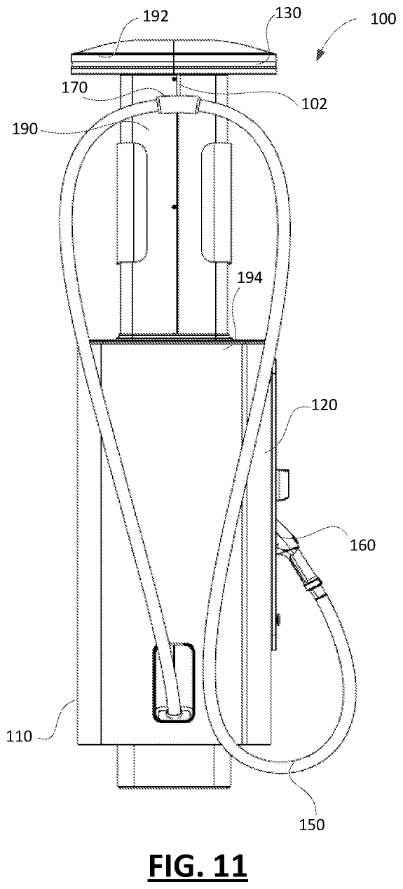

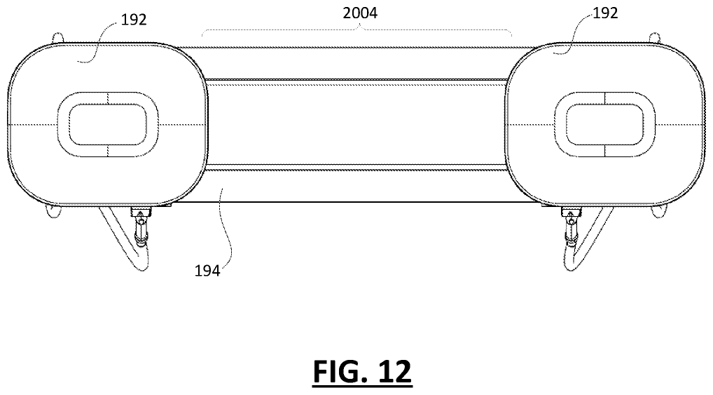

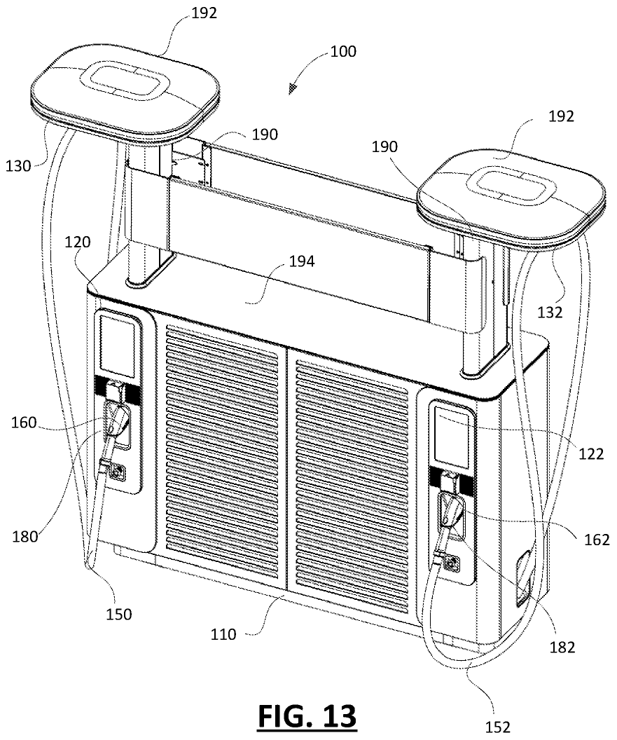

An example EV charging station 100 in a same side or pull-in orientation is illustrated in FIGS. 9 to 13.

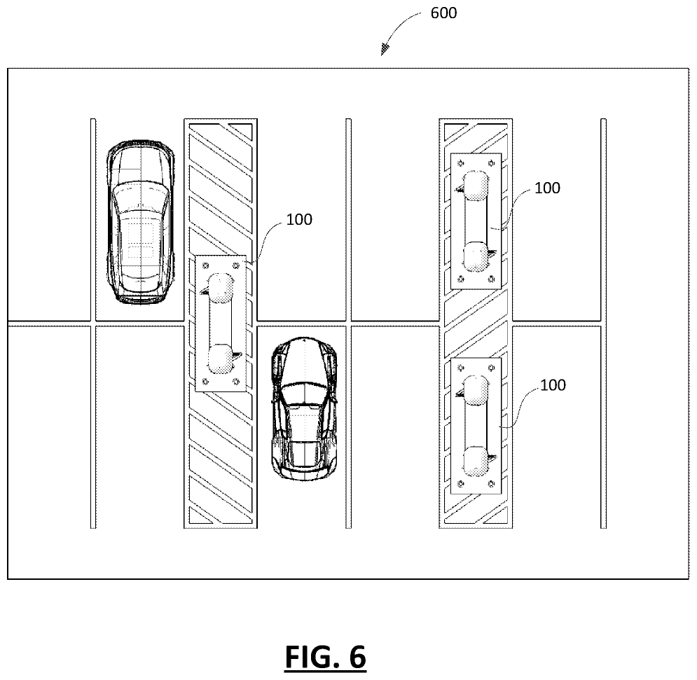

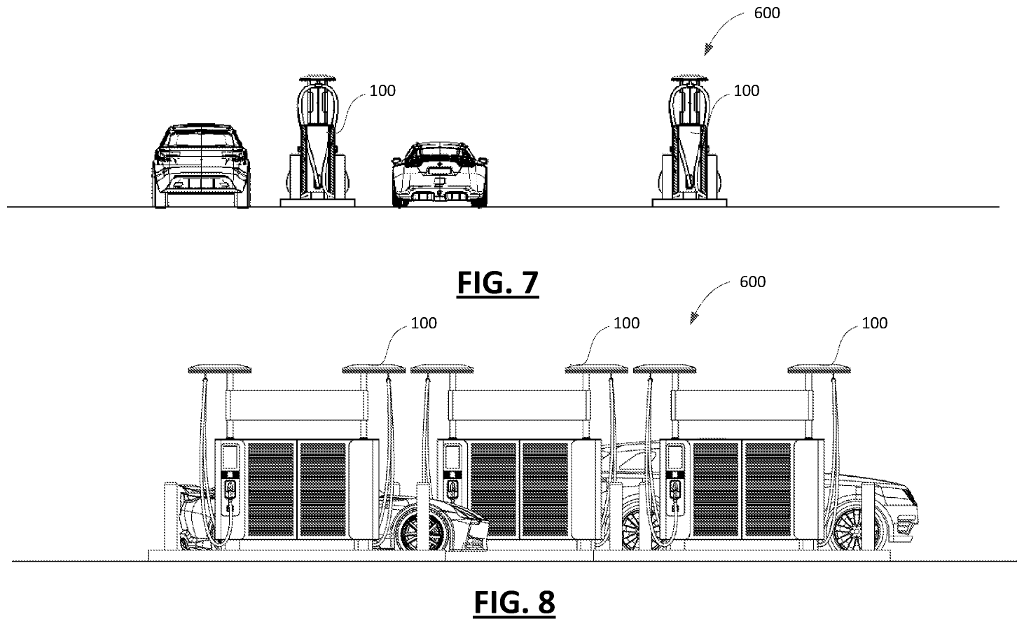

A pull-through style deployment 600 will now be discussed with reference to FIGS. 6 to 8. As best illustrated in FIG. 6, a pull-through deployment is one in which cars pull up to the EV charging station 100 by driving alongside the EV charging station 100. That is, a vehicle may drive in and park parallel to the EV charging station 100; for example, parallel to a front side and/or rear side of the EV charging station 100.

A pull-through system deployment 600 may offer one or more advantages. This type of deployment may be useful, for example, when retrofitting a gas station with EV charging stations 100. This type of deployment may also, if desired, be used in some parking lots. This type of deployment may allow for easier access for vehicles having trailers such as recreational vehicle (RV) trailers and campers, other RVs, and other large vehicles such as semi trucks, farm machinery and tractor trailers.

As illustrated, the pull-through system deployment 600 may include EV charging stations 100 having EV chargers 120, 122 on opposing sides. For example, a first EV charger 120 may be on a front side (relative to the orientation of FIG. 1) and a second EV charger 122 may be on a rear side. In this way, a vehicle may be charged on each of the sides by pulling up next to the EV charging station 100.

Since the deployment of FIG. 6 uses substantially the same EV charging station 100 as the deployment of FIG. 3, the sizing may be as described above. In at least some implementations and for at least some deployments, the sizing may reduce power hogging issues. Further, in the illustrated example, the EV chargers are provided at different sides (one front and one back) and at opposite ends of the EV charging system 100. That is, one of the EV chargers 120, 122 is not immediately behind the other; they are at different ends. This kitty corner or diagonal positioning may also frustrate power hogging since it would be difficult or impossible to impede both EV chargers 120, 122 with a single vehicle.

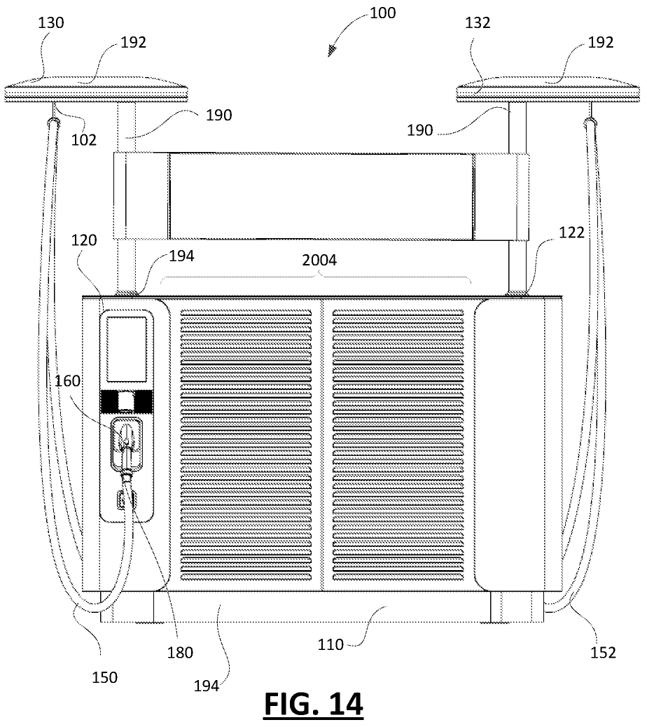

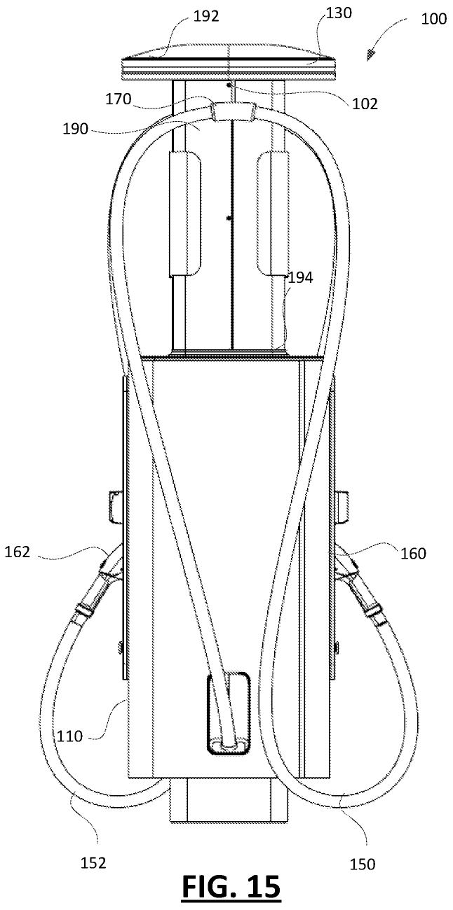

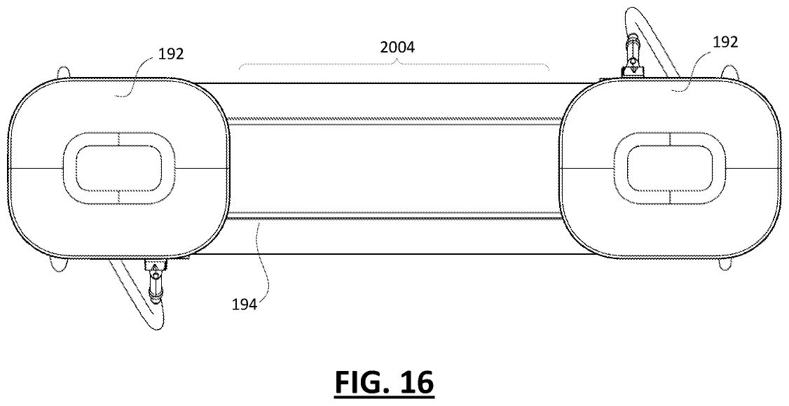

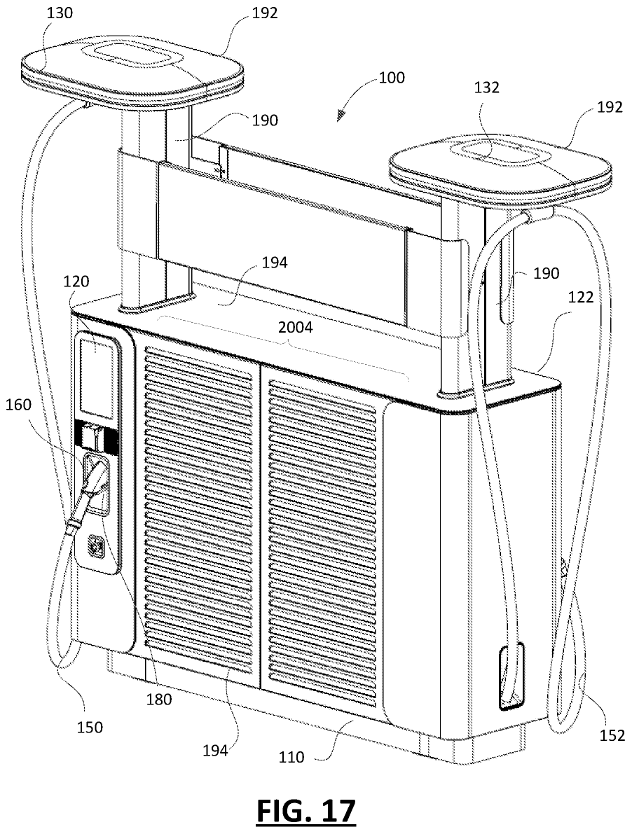

An example EV charging system in an opposite side or pull-through orientation is illustrated in FIGS. 14 to 17.

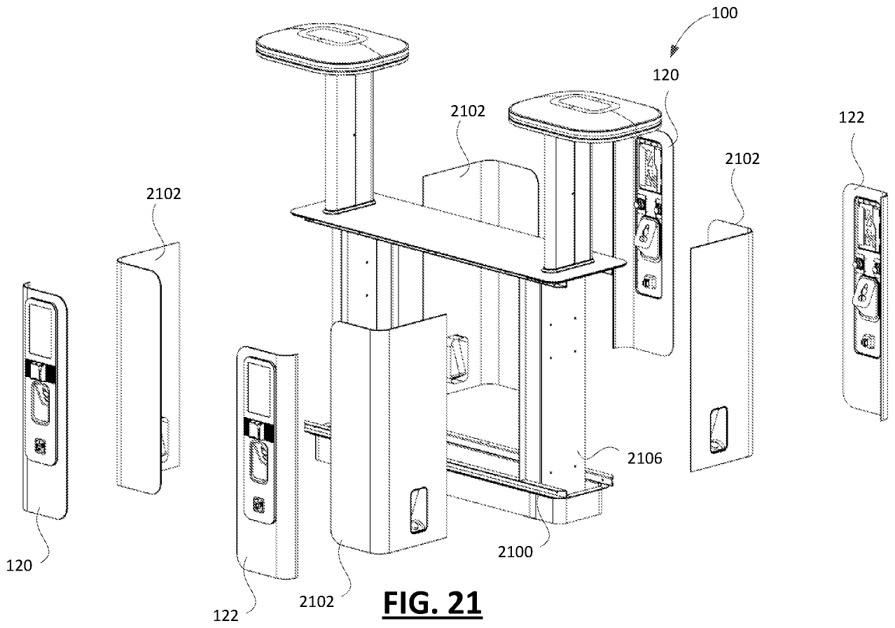

Referring now to FIG. 21, it will now be shown how the same unit may be converted to or configured as a same-side unit of the type described above with reference to FIGS. 3 to 5 and 9 to 13 or to an opposing side unit of the type described above with reference to FIGS. 6 to 8 and 14 to 17.

The EV charging station 100 includes a frame 2100 which may receive one or more exterior panels. The panels for the power cabinet 2004 may be the same for both the same-side units and the opposing side units and so they have not been shown in FIG. 21 for clarity of reference.

The portions of the EV charging station 100 that are associated with an EV charger 120, 122 may be configured using interchangeable panels that attach to the frame 2100. For example, a left side region of the front face, a right side region of the front face, a left side region of the rear face and a right side region of the rear face may each be configured with either a EV charger 120, 122 (which may also be referred to as an EV charger panel) or with a backer panel 2102 which may also be referred to as a dummy panel. An EV charger panel may include customer equipment, such as a holster 180, 182 and/or interface (such as a display screen) Each of the left side and the right side has one EV charger 120 and one backer panel 2102 but the side which has the EV charger 120, 122 and the side that has the backer panel 2102 may be varied. The panels and EV chargers are affixed to the frame 2100; for example, by bolting or by another attachment technique.

In the illustrated example, the backer panels 2102 act as both backers for the EV chargers 120, 122 and also as side panels for the left and right sides of the EV chargers 120, 122 and the EV charging station 100 itself. In other implementations, separate side panels may be used.

The side panels may include an outlet for a charging cable.

An EV charging station 100 can, using the described architecture, be easily converted from a same side orientation to an opposite side orientation. This may make refurbishments, retrofits and changing deployments quite simply.

As illustrated, the frame 2100 may include an internal sidewall 2106 which provides separation between the power cabinet and the EV chargers. The internal sidewall 2106 may have one or more holes for passing cables from the power cabinet to the EV chargers.

Methods of converting a same side unit to an opposing side unit (or vice versa) are contemplated and may include removing an EV charges or EV charger panel and replacing that panel with a backer panel and may also include removing a backer panel and replacing that backer panel with an EV charger or EV charger panel.

As best illustrated in FIGS. 2, 11 and 15, the mechanical wire 102 that extends from the upper housing 192, such as the lighting canopy 130, 132 may extend from an outlet that is aligned with a midpoint of side of the EV charging station 100. For example, the mechanical wire 102 may pass through an outlet port of the enclosure 110 that houses the cable management system that retracts and extends the mechanical wire 102 or which houses a portion of that cable management system. The outlet port serves to pass the mechanical wire 102 from inside the enclosure to outside the enclosure 110. This outlet port may be located in alignment with a midpoint of one or more of a side of the EV charging station 100, a side of the lower housing 194, a side of the canopy 130, 132, a side of the support 190, a side of the upper housing 192. Put differently, a vertical plane passing through the midpoint of a side of one or more of the EV charging station 100, the lower housing 194, the canopy 130, 132, the support 190, and/or the upper housing 192 also passes through the outlet port which passes the mechanical wire 102 and, in at least some implementations, a midpoint of the outlet port. In at least some implementations, the outlet port may be located in alignment with a midpoint of two or more of a side of the EV charging station 100, a side of the lower housing 194, a side of the canopy 130, 132, a side of the support 190, a side of the upper housing 192. In at least some implementations, the outlet port may be located in alignment with a midpoint of three or more of a side of the EV charging station 100, a side of the lower housing 194, a side of the canopy 130, 132, a side of the support 190, a side of the upper housing 192. In at least some implementations, the outlet port may be located in alignment with a midpoint of all of: a side of the EV charging station 100, a side of the lower housing 194, a side of the canopy 130, 132, a side of the support 190, a side of the upper housing 192.

By positioning the outlet port so that the mechanical wire is extended at or near the middle of the side of the EV charging station 100, the cable management system that retracts and extends the cable may operate in exactly the same manner irrespective of whether an EV charger 120, 122, having a charging cable 150, 152 attached to that mechanical wire 102 is located on a front side of the EV charger or a rear side of the EV charger. The cable management system need not even be programmed any differently in situations in which the associated EV charger is on the front side than if it were on the rear side. Put differently, a controller associated with the cable management system that controls a motor that causes retraction or extension of the cable may be configured without any indication of which of the sides the EV charger is situated on. The cable management system may service EV chargers on each of the sides equally well. Conveniently, locating the outlet port in this manner may allow for easy configuration of the EV charging station 100 since no configuration or reprogramming of the cable management system is required when the side of the EV charger is changed from one side to another.

Methods of configuring EV charging stations in different configurations using a common structure, such as a common frame and other common components are contemplated and will now be described.

For example, in some implementations, a method may include steps of configuring a first EV charging station as a same-side charging station and configuring a second EV charging station as an opposite-side charging station. The first EV charging station and the second EV charging station may include commonly-configured structures.

The first EV charging station may be configured as a same-side charging station, which may also be referred to as a pull-up configuration or a pull-up charging deployment. An example of such an EV charging station is illustrated in FIGS. 9 to 13. The second EV charging station may be configured as an opposite-side charging station, which may also be referred to as a pull-through configuration or a pull-through charging deployment. An example of such an EV charging station is illustrated in FIGS. 14 to 19.

The first EV charging station may be configured as a same-side charging station as follows. A first EV charger panel may be installed at a front side of the first EV charging station. For example, the first EV charger panel may be attached to a frame of the first EV charging station. A second EV charger panel may also be installed at the same side as the first EV charger panel; that is, at the front side. The front side may be a longitudinal side. A first backer panel may be installed behind the first EV charger panel (i.e., on a rear side of the first EV charging station) and a second backer panel may be installed behind the second EV charger panel (i.e., on the rear side of the first EV charging station). The rear side of the first EV charging station may be a longitudinal side. The rear side may be substantially parallel to the front side. The same-side charging station may have one EV charger panel situated at a left side of the first EV charging station and another EV charger panel situate at a right side of the first EV charging station.

The second EV charging station may be configured as an opposite-side charging station as follows. Another first EV charger panel may be installed at a front side of the second EV charging station. For example, this EV charger panel may be attached to a frame of the first EV charging station. Another second EV charger panel may be installed at a rear side of the second EV charging station. The front and rear sides of the first EV charging station may be longitudinal sides. The rear side may be substantially parallel to the front side. The rear side may be a side that is opposite the front side. Backer panels may then be installed opposite the EV charger panels. For example, a backer panel (which may be referred to as another first backer panel) may be installed behind the first EV charger panel (i.e., on a rear side of the second EV charging station) and a backer panel (which may be referred to as another second backer panel) may be installed in front of the second EV charger panel (i.e., on the front side of the second EV charging station)

The backer panels may be covers, such as cover plates. The backer panels are used to occupy a space that could, in some configurations, be used for mounting an EV charger panel. For example, the first EV charging station and the second EV charging station may each define a number of openings and the openings may be occupied by either a backer panel or an EV charger panel. The openings may be defined by a frame of the respective EV charging station.

The backer panels may be mounted on the EV charging stations to cover an opening that is the same size as the opening used to mount an EV charger panel. Put differently, at least one of the backer panels may be interchangeable with at least one of the EV charger panels on an EV charging station. That is, at least one of the backer panels and at least one of the EV charger panels on each EV charging station are interchangeable panels. That is, the panels may be selectively used to either add EV charging capabilities to the opening by coupling an EV charger panel to cover the opening or to simply close the opening with the backer panel.

The backer panels may have fastening features, such as screw holes, in common orientations as the EV charger panels such that the backer panels may be mounted in one of the EV charging stations using corresponding fastening features on the EV charging station, such as corresponding features on the frame. By way of example, an opening that is covered with an EV charging panel may have the same hole arrangement (or other fastening feature arrangement) as an opening that is covered with a backer panel.

The backer panels may be mounted to cover an opening that is the same size as an opening used to mount an EV charger panel.

The first and the second EV charging stations including commonly configured structures to which the EV charger panels and the backer panels are attached. For example, the first and second EV charging stations may include commonly-configured frames. The frames may be identical, for example. In some implementations, the frames may have common external dimensions and may define common openings. The first EV charging station and the second EV charging station may have a common width and a common height. The first and second EV charging stations may have a common width which may be, for example, between 74 and 100 inches.

The first EV charging station and the second EV charging station may both have features the same or similar to those described above. The first EV charging station and the second EV charging station may, for example, have a power module cabinet situated between a first EV charger and a second EV charger. The first EV charger may be associated with one EV charger panel and the second EV charger may be associated with another EV charger panel. In some implementations, the first and second EV charging stations may each include a first EV charger at a first side. The first EV charger may be associated with the first EV charger panel in the case of the first EV charging station and with the another first EV charger panel in the case of the second EV charging station. The first and second EV charging stations may also include a second EV charger at a second side. The second EV charger may be associated with the second EV charger panel in the case of the first EV charging station and with the another second EV charger panel in the case of the second EV charging station. The first EV charging station and the second EV charging station may each have respective power module cabinet portions between the respective first EV chargers and second EV chargers. The power module cabinet may house one or more power modules configured to dynamically distribute power to the first EV charger and the second EV charger. The power module cabinet portions may have a common configuration for both the first and second EV charging stations. For example, the power module cabinets may be common parts, having common dimensions.

The first and second EV charging stations may be commonly configured with common components apart from the differing configurations of the EV charging panels. By way of example, these EV charging stations may have the same external dimensions, apart from the differing configurations of the EV charging panels. By way of further example, these EV charging stations may have the same external shapes, apart from the differing configurations of the EV charging panels.

The first EV charger panel may be installed at a left side of the first EV charging station and the second EV charger panel may be installed at a right side of the EV charging station. Similarly, the another first EV charger panel may be installed at a left side of the second EV charging station and the another second EV charger panel may be installed at a right side of the second EV charging station. In this way, each EV charging station may have both a left and right side charger.

Conveniently, a same side EV charging station may be converted to an opposite-side charging station and an opposite-side charging station may be converted to a same-side charging station. For example, the method may include converting the first EV charging station from a same-side charging station to an opposite side charging station by replacing the first backer panel with an EV charger panel and replacing the first EV charger panel with a backer panel.

In some implementations, the method may include converting the second EV charging station from an opposite-side charging station to a same-side charging station by replacing the another first backer panel with an EV charger panel and replacing the another first EV charger panel with a backer panel. That is, one of the backer panels may be exchanged for an EV charger panel and one of the EV charger panels may be exchanged with an EV charger panel.

As illustrated in FIG. 21, the backer panels 2102 may also operate as side panels, covering a side of the EV charging station.

As noted, certain adaptations and modifications of the described embodiments can be made. Therefore, the above discussed embodiments are considered to be illustrative and not restrictive.

1. A monolithic electric vehicle (EV) charging station comprising:
a first EV charger at a first side;
a second EV charger at a second side; and
a power module cabinet portion between the first EV charger and the second EV charger, the power module cabinet housing one or more power modules configured to dynamically distribute power to the first EV charger and the second EV charger.

2. The monolithic EV charging station of claim 1, wherein a width of the monolithic EV charging station is within 5% of a width of a parking space at which the EV charging station is deployed.

3. The monolithic EV charging station of claim 1, wherein a width of the monolithic charging station is between 74 and 100 inches.

4. The monolithic EV charging station of claim 3, wherein the EV charging station is situated in a position in which the first EV charger is at an approximate midpoint of a first parking space and the second EV charger is at an approximate midpoint of a second parking space.

5. The monolithic EV charging station of claim 1, wherein the first EV charger and the second EV charger are dispensers which dispense supplied power from the one or more power modules and which do not, themselves, include power modules.

6. The monolithic EV charging station of claim 1, wherein the first EV charger and the second EV charger provide a buffer zone to reduce the effect on the power modules from an impact at one or more sides of the EV charging station.

7. The monolithic EV charging station of claim 1, wherein the first and second EV chargers are mounted to a frame and wherein at least one of the first and second EV chargers are configured with a removable portion associated with a holster which may be replaced with a backer panel, and wherein that at least one of the first and second EV chargers includes a backer panel behind that removable portion which is configured to be replaced with a removable portion associated with a holster to convert the EV charging station between a same-side station and an opposite-side station.

8. The monolithic EV charging station of claim 1, wherein the first EV charger has a first columnar region and wherein the second EV charger has a second columnar region and wherein the first and second columnar regions extend above the power module cabinet to visually distinguish the first and second EV chargers.

9. The monolithic EV charging station of claim 1, further comprising:
a first lighting canopy associated with the first EV charger and mounted above the first EV charger; and
a second lighting canopy associated with the second EV charger and mounted above the second EV charger,
wherein the first lighting canopy and the second lighting canopy are separate and distinct lighting canopies.

10. The monolithic EV charging station of claim 9, further comprising:
a controller coupled with the first EV charger and the second EV charger and a first light associated with the first lighting canopy and a second light associated with the second lighting canopy, and wherein the controller is configured to control the first light to indicate whether the first EV charger is available for use and to control the second light to indicate whether the second EV charger is available for use.

11. A method of configuring EV charging stations in different configurations using a common structure, the method comprising:
configuring a first EV charging station as a same-side charging station by:
installing a first EV charger panel at a front side of the first EV charging station;
installing a second EV charger panel at the front side of the first EV charging station;
installing a first backer panel behind the first EV charger panel; and
installing a second backer panel behind the second EV charger panel; and
configuring a second EV charging station as an opposite-side charging station by:
installing another first EV charger panel at a front side of the second EV charging station;
installing another second EV charger panel at a rear side of the second EV charging station;
installing another first backer panel behind the first EV charger panel; and
installing another second backer panel in front of the second EV charger panel,
and wherein the first and second EV charging stations include commonly-configured structures to which the EV charger panels and backer panels are attached.

12. The method of claim 11, wherein the commonly-configured structures include commonly-configured frames.

13. The method of claim 11, wherein the first EV charging station and the second EV charging station have a common width and height.

14. The method of claim 13, wherein the common widths is between 74 and 100 inches.

15. The method of claim 11, wherein each of the first and second EV charging stations include:
a first EV charger at a first side, the first EV charger associated with the first EV charger panel in the case of the first EV charging station and with the another first EV charger panel in the case of the second EV charging station;
a second EV charger at a second side, the second EV charger associated with the second EV charger panel in the case of the first EV charging station and with the another second EV charger panel in the case of the second EV charging station; and
a power module cabinet portion between the first EV charger and the second EV charger, the power module cabinet housing one or more power modules configured to dynamically distribute power to the first EV charger and the second EV charger,
wherein the power module cabinet portions have a common configuration for both the first and second EV charging stations.

16. The method of claim 11, wherein the first and second EV charging stations are commonly configured with common components apart from differing configurations of the EV charging panels.

17. The method of claim 11, further comprising:
converting the first EV charging station from a same-side charging station to an opposite side charging station by:
replacing the first backer panel with an EV charger panel and replacing the first EV charger panel with a backer panel.

18. The method of claim 11, further comprising:
converting the second EV charging station from an opposite-side charging station to a same-side charging station by:
replacing the another first backer panel with an EV charger panel and replacing the another first EV charger panel with a backer panel.

19. The method of claim 11, wherein the first EV charger panel is installed at a left side of the first EV charging station and wherein the second EV charger panel is installed at a right side of the EV charging station, and wherein the another first EV charger panel is installed at a left side of the second EV charging station and the another second EV charger panel is installed at a right side of the second EV charging station.
